(19) United States
(12) Patent Application Publication
(10) Pub. No.: US 2008/0144068 A1
(43) Pub. Date: Jun. 19, 2008

(54) Printer with image categorization capability

(75) Inventor: Anthony Digby, Widmer End (GB)

Correspondence Address: FAY SHARPE / XEROX - ROCHESTER, 1100 SUPERIOR AVE., SUITE 700, CLEVELAND, OH, 44114, US

(73) Assignee: XEROX CORPORATION.

(21) Appl. No.: 11/637,984

(22) Filed: Dec. 13, 2006

(51) Int. Cl. G06F 3/12

(52) U.S. Cl. 358/1.13

(57) ABSTRACT

A printer includes an acquisition component which acquires image data comprising a set of digital images generated by a digital image generation device, such as a camera. The acquired set of images is stored in memory. A user input device enables a user to select an image category from a plurality of image categories. A processor in communication with the input device and memory identifies a subset of the digital images based on the image category selected by the user. The processor includes a classifier trained to classify images according to image content. A display in communication with the processor displays images in the subset. A marking engine in communication with the processor prints images from the subset selected by the user.

### CROSS REFERENCE TO RELATED PATENTS AND APPLICATIONS

The following co-pending applications, the disclosures of which are incorporated herein by reference in their entireties, are mentioned:

U.S. patent application Ser. No. 11/418,949, filed May 5, 2006, entitled GENERIC VISUAL CLASSIFICATION WITH GRADIENT COMPONENTS-BASED DIMENSIONALITY ENHANCEMENT, by Florent Perronnin;

U.S. patent application Ser. No. 11/170,496, filed Jun. 30, 2005, entitled GENERIC VISUAL CATEGORIZATION METHOD AND SYSTEM, by Florent Perronnin;

U.S. patent application Ser. No. 11/524,100 (Atty. Docket No. 20060463-US-NP), filed Sep. 19, 2006, entitled BAGS OF VISUAL CONTEXT-DEPENDENT WORDS FOR GENERIC VISUAL CATEGORIZATION, by Florent Perronnin; and

U.S. patent application Ser. No. 11/524,236 (Atty. Docket No. 20060497-US-NP), filed Sep. 19, 2006, entitled DOCUMENT PROCESSING SYSTEM, by Christopher Dance, et al.

### BACKGROUND

The exemplary embodiment relates to printing of images. It finds particular application in connection with a printing system which enables image characterization for identifying images which a responsive to a user-selected category, for printing. However, it is to be appreciated that the exemplary embodiment may find application in other image selection processes.

Widespread availability of digital cameras and other direct-digital imagers, and the low cost of storing images have led to the generation of large numbers of digital images making retrieval of selected images problematic. When a user desires to print a selected group of images, such as images of people, cars, or the like, it can take some time for the user to review the stored images and identify the images which meet the selection criteria.

Accordingly, there is interest in developing techniques for classifying images based on content, so as to facilitate image selection and other like applications.

### INCORPORATION BY REFERENCE

U.S. patent application Ser. No. 11/418,949, incorporated herein by reference in its entirety, discloses a system and method for classifying an image. Model fitting data are extracted for the image respective to a generative model that includes parameters relating to visual words of at least an image class-specific visual vocabulary. A higher-dimensionality representation of the model fitting data is computed that includes at least some components of a gradient of the model fitting data in a vector space defined by the parameters of the generative model. The extracting and computing are repeated for a plurality of generative models each having at least a different image class-specific vocabulary corresponding to a different class of images. The image is classified based on the higher-dimensionality representations.

Csurka, et al., Visual Categorization with Bags of Keypoints, ECCV International Workshop on Statistical Learning in Computer Vision, Prague, 2004, discloses a method for generic visual categorization based on vector quantization.

### BRIEF DESCRIPTION

In accordance with one aspect of the exemplary embodiment, a printer includes an acquisition component which acquires image data comprising a set of digital images generated by a digital image generation device. The printer further includes memory which stores the acquired set of images and a user input device through which a user selects an image category from a plurality of image categories. A processor in communication with the input device and memory identifies a subset of the digital images based on the image category selected by the user. The processor includes a classifier trained to classify images according to image content. A display in communication with the processor displays images in the subset. A marking engine in communication with the processor prints images from the subset selected by the user.

In another aspect, in a printer comprising an acquisition component, a user input device, an automated classifier which is trained to classify images based on image content, and a marking engine, a method for processing images is provided. The method includes acquiring image data with the acquisition component, the image data comprising a set of digital images. A class of images of interest is identified based on information received from the user input device. The digital images are classified with the automated classifier to identify a subset of the set of digital images in the identified class. Images in the subset of digital images are displayed, whereby a user is able to select images from the subset for printing by the marking engine.

In another aspect, a method includes transferring digital image data comprising a set of photographs from a camera to a printer, storing the set of images in memory of the printer, receiving a user input query from a graphical user interface, identifying a subset of the images responsive to the query based on image content, displaying the subset of images on the graphical user interface, and printing images from the subset selected by the user.

### BRIEF DESCRIPTION OF THE DRAWINGS

FIG. 1 is a functional block diagram of a printer in accordance with one aspect of the exemplary embodiment;

FIG. 2 is a schematic view of an image selection and rendering system comprising the printer of FIG. 1;

FIG. 3 illustrates a method for image selection and rendering according to another aspect of the exemplary embodiment;

FIG. 4 illustrates the graphical user interface of FIG. 1 during execution of the method of FIG. 3.

### DETAILED DESCRIPTION

Aspects of the exemplary embodiment disclosed herein relate to a printer and to a method for automated selection of images for rendering on a printer.

The exemplary method may include transferring digital data comprising a set of images from a digital image generation device, such as a camera, to a printer, classifying the images based on the image content, and identifying a subset of the images corresponding to a user-selected category for printing on the printer. The exemplary method enables a user to select a category of images from a plurality of categories, view the subset of images identified by the printer as corresponding to the category, and select one or more of the images in the subset for printing by the printer.

In another aspect, the exemplary printer may include an acquisition component for receiving image data comprising images and a storage device comprising memory for storing the image data. A graphical user interface allows a user to select a category of images for rendering. An image classifier trained to classify images according to their content processes the image data to identify images in a class corresponding to the user-selected category.

An advantage of at least some aspects of the exemplary embodiment is that a reduced set of images is automatically identified which is responsive to a user query, allowing selection of images to be made more easily by the user of the printer. Another advantage of at least some aspects of the exemplary embodiment is that the classifier is incorporated into the printer as a unitary device, avoiding the need for identifying images at a location remote from the printer or for providing a network interface to the printer. The exemplary graphical interface is easy to use, enabling images to be selected by a user for printing without visually examining all of the images and without the need for access to a general purpose computer.

As used herein, the image rendering device or “printer” can include any device for rendering an image on print media, such as a printer, bookmaking machine, or a multifunction machine having one or more of copying, faxing, emailing, and/or other functions. In general, a printer includes one or more marking engines which render images on tangible print media.

“Print media” can be a usually flimsy physical sheet of paper, plastic, or other suitable physical print media substrate for images. An image, as used herein, generally may include two-dimensional information in electronic form which is to be rendered and may include graphics, photographs, and the like. In various aspects, the images are photographs captured by a camera or other image generation device. Images may include JPEG, GIF, BMP, TIFF, PDF, or other image formats. The images may be monochrome, such as black and white images, or color images with image data expressed in two or more color dimensions which can be rendered with two or more colorants, such as inks or toners by a color printer. The operation of applying images to print media, for example, graphics, photographs, etc., is generally referred to herein as printing.

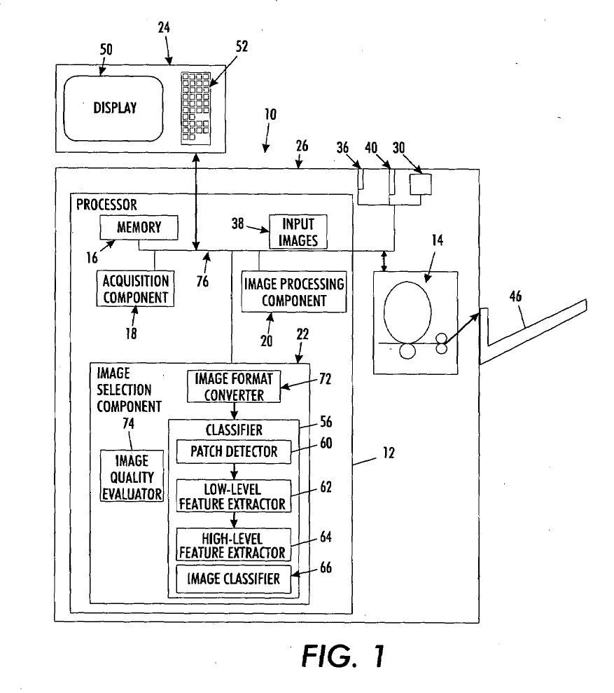

With reference to FIG. 1, a printer 10 includes a processor 12, which serves as a marking engine control system, and at least one marking engine 14. The processor 12 may be in the form of a dedicated computing device and may comprise a central processing unit (CPU), which runs various image processing applications, stored in memory 16, herein illustrated as processing components. The processing components may include an image data acquisition component 18, an image processing component 20, and an image selection component 22, although it will be appreciated that there may be additional processing components or that two or more of the components may be combined. The image data acquisition component 18 and image selection component 22 may be processing components provided as a software plug in to the marking engine control system 12, or may be integral with the control system 12 or entirely separate therefrom. A user input device 24, such as a graphical user interface, is in communication with the control system 12. The user input device allows a user to input a query, such as a category of images to be retrieved, to the selection component 22. A housing 26, provides a containing structure for the marking engine 14. The illustrated printer 10 is a stand alone device in which all of the components 12, 14, 16, 24 are supported within or on the housing 26. In this way, if the printer 10 is moved to a different location, the components are automatically relocated with the printer.

The memory 16 may represent any type of computer readable medium such as random access memory (RAM), read only memory (ROM), magnetic disk or tape, optical disk, flash memory, or holographic memory. In one embodiment, the memory 16 comprises a combination of random access memory and read only memory. In some embodiments, the memory 16 may be combined with one or more of the processing components into a single chip.

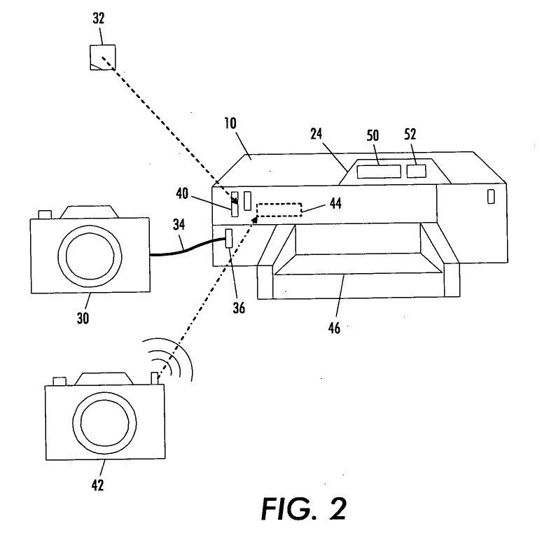

With reference also to FIG. 2, which illustrates an image selection and rendering system incorporating the printer 10, the acquisition component 18 acquires image data from an image input device, such as a mobile digital image generation device 30 or an image storage medium 32. The mobile digital image generation device 30 can be a camera, mobile phone with embedded camera, web cam, or the like and may be battery powered for ease of portability. The mobile digital image generation device 30, here illustrated as a camera, includes an image storage medium 32, such as a memory card or hard drive, on which image data comprising one or more digital images is stored while on the device 30. The digital image generation device 30 may communicate with the printer 10 via a wired link 34, such as a USB connector, which may be temporarily connected between the device 30 and a device interface 36 on the printer, such as a USB port, defined by the housing 26, when the device 30 is proximate the printer. When connected in this way, the illustrated image data acquisition component 18 acquires images 38 from the camera 30 and stores them in associated memory, which may be the same memory 16 as that used for the processor instructions or a separate memory.

In another embodiment, the device interface may comprise a socket 40, defined by the housing 26, which receives the memory card 32 for transferring the images to the memory 16 of the printer 10. To accommodate different sized memory cards, a plurality of such sockets 40 may be provided. In yet another embodiment, a digital image generation device 42 similar to device 30 but with wireless communication capability, transmits the images to the printer 10 wirelessly. In this embodiment, a wireless device interface 44 of the printer 10 may include a pairing module which detects the wireless device 44 when in close proximity thereto, e.g. within about 10 meters of the printer 10. Other memory storage devices 32 for supplying the images to the printer are also contemplated, such as a floppy disk, flash memory, or the like. In each case, the acquisition component 18 captures the images from the device 30, 42 or storage device 32 and stores them in the memory 16. Other image data may accompany each of the images, such as a time stamp, camera parameters, such as aperture and speed, an alphanumeric identifier for the image, and the like.

The illustrated device interface(s) 36, 40, 44, like the other components of the printer 10, are integral with the printer, and in general may be supported by or within the housing 26. In this way, if the printer 10 is moved to a different location, the device interface 36, 40, 44 is automatically relocated with the printer.

The image processing component 20 receives incoming images in device independent format and converts the images to a format in which they can be rendered by the marking engine 14. As is known in the art, the conversion may include the conversion of color values for pixels of the image from device independent color space, such as RGB, to device dependent color space, such as CMYK (in the case of a marking engine using the four colorants: cyan magenta, yellow, and black). The marking engine 14 receives the image data from the control system 12 and renders the image on the print media using colorants, such as toners or inks. The marking engine 14 may be a xerographic marking engine, inkjet marking engine, or other suitable marking device for applying colorants to print media. The prints formed by the marking engine may be output to a finisher 46, herein illustrated as a paper tray.

In one embodiment, the marking engine is a xerographic marking engine which includes many of the hardware elements employed in the creation of desired images by electrophotographical processes. In the case of a xerographic device, the marking engine typically includes a charge retentive surface, such as a rotating photoreceptor in the form of a belt or drum. The images are created on a surface of the photoreceptor. Disposed at various points around the circumference of the photoreceptor are xerographic subsystems which include a cleaning device, a charging station for each of the colors to be applied (one in the case of a monochrome printer, four in the case of a CMYK printer), such as a charging corotron, an exposure station, which forms a latent image on the photoreceptor, a developer unit, associated with each charging station for developing the latent image formed on the surface of the photoreceptor by applying a toner to obtain a toner image, a transferring unit, such as a transfer corotron transfers the toner image thus formed to the surface of a print media substrate, such as a sheet of paper, and a fuser, which fuses the image to the sheet. The fuser generally applies at least one of heat and pressure to the sheet to physically attach the toner and optionally to provide a level of gloss to the printed media.

While particular reference is made to electrophotographic printers, suitable marking engines may also include ink-jet printers, including solid ink printers, thermal head printers that are used in conjunction with heat sensitive paper, and other devices capable of marking an image on a substrate.

The selection component 22 identifies a subset of the acquired images that are responsive to a user query. In the illustrated embodiment, the query is input by a user utilizing the user interface 24. The illustrated graphical user interface includes a display unit 50, such as an LCD touch screen and/or an associated alphanumeric keypad 52. The display unit 50 displays selectable options, viewable by a user, in response to a user command and/or the control of the CPU 12 by which a user may input a query for defining a class of images of interest. In the exemplary embodiment, the graphical user interface 24 also allows a user to select printing parameters, such as one or more of the number of prints to be made, color or black and white printing, print size, type of print media, e.g., glossy or matte finish, and/or other parameters. In the illustrated embodiment, the graphical user interface is integral with the printer 10, e.g., mounted to a top of the housing 26. Other user input devices, such as one or more of a keyboard, computer mouse, touch pad, either on the printer or linked thereto via a network, are also contemplated.

In one embodiment, the control system 12 causes the screen 50 to display a menu which enables the user to select a category of images to form a subset of the acquired images. For example, by highlighting, e.g., by touching a portion of the screen 50, and/or by entering a query on the keypad 52, a user can define a query to be input to the selection component 22. Based on the information input by the user, the selection component 22 defines a class of images to be identified.

The selection component 22 includes a classifier 56 for classifying images into one or more designated classes, bases on features of the input images. In particular, the classifier may include software for distinguishing features of images. Images can then be labeled according to which of the features are identified within the image. Based on the identified features, the image may be classified into one (or more) designated classes.

For example, the classifier 56 may identify distinguishable portions of people, locations, and the like, such as faces, circular objects, which because of their spatial relationships and relationships to other features may be identified as wheels, specific clothing indicative of an event, such as numbered jerseys of athletes indicative of a sporting event, formal attire indicative of a wedding event, and the like. Exemplary classifiers which may be utilized include those described in U.S. patent application Ser. Nos. 11/418,949; 11/170,496; 11/524,100 and 11/524,236 incorporated herein by reference.

One approach that may be used for classification of the input images is the “bag-of-words” concept derived from text document classification schemes. In text document bag-of-words classification schemes, clustering techniques are applied to group documents based on similarity in word usage. Such clustering techniques group together documents that share similar vocabularies as measured by word frequencies, word probabilities, or the like. Extension of bag-of-words approaches to image classification involves generating an analog to the word vocabulary. In some approaches, a visual vocabulary is obtained by clustering low-level features extracted from training images, using for instance K-means. In other approaches, a probabilistic framework is employed, and it is assumed that there exists an underlying generative model such as a Gaussian Mixture Model (GMM). In this case, the visual vocabulary is estimated using the Expectation-Maximization (EM) algorithm. In either case, each word corresponds to a grouping of typical low-level features. It is hoped that each visual word corresponds to a mid-level image feature such as a type of object (e.g., ball or sphere, rod or shaft, or the like), characteristic background (e.g., starlit sky, blue sky, grass field, or the like).

These approaches may be modified to take into account surrounding context, such as whether a visual word corresponding to a generally round sphere is in a blue sky suggestive that the sphere is the sun, or in a grass field suggestive that the sphere is a game ball, and the like. In context-based visual classifiers of this type, a set of contexts are identified as a kind of “context vocabulary”, in which each context is a geometrical arrangement or grouping of two or more visual words in an image. In some existing techniques, training images are analyzed to cluster contexts of words to define the context vocabulary, and the image classification entails identifying such clustered contexts in the image being classified. This approach works relatively well for well-structured objects such as bicycles, persons, and so forth. For other objects, such as those associated with landscapes, a more detailed analysis may be appropriate, such as that described in application Ser. No. 11/524,100.

The exemplary classifier 56 includes components for identifying features within the images. Based on the identified features, the classifier classifies the image into one of a plurality of classes. The illustrated classifier includes a patch detector 60, one or more feature extractors, herein illustrated as a low level feature extractor 62 and a high level feature extractor 64, and an image classifier 66, some or all of which may be trained on a set of training images, as described in above-mentioned application Ser. Nos. 11/418,949 11/170,496, 11/524,100 and 11/524,236 incorporated herein by reference.

The patch detector 60 identifies regions of interest (patches) of an image which are likely sources of features. The patch detector 60 may be omitted if, for example, the patches are selected based on a grid.

The low-level feature extractor 62 extracts low-level information (features) from the patches of the image identified by the patch detector 60. Examples of such low-level information may include texture, shape, color, and the like. The high-level feature extractor 64 transforms a set of local low-level features into a high level representation comprising one (or more) global high-level feature(s) which characterizes the content of the image as a whole.

The image classifier 66 then assigns an image class to the image based on the computed high-level feature. For example, an image which includes high-level features identified as tires and headlights may be assigned to a class “motor vehicle” or “car.” The classes may include descriptive classes, such as, landscape, beach, animal, person, face, car, plane, sporting event, wedding, etc. These classes are exemplary only. It is to be appreciated that the classifier may include fewer or more classes and that some or all the classes may include subclasses. In one embodiment, the classifier includes an image classifier for each of the designated classes. The respective classifiers may each provide a yes-or-no assignment of the image to that class or a confidence-weighted assignment.

The output of the image classifier 56 may be an assignment of each input image to an image class selected from a set of image classes, wherein one (or more) of the classes is responsive to the user query. Or, in another embodiment, the classifier 56 may assign each input image to only one of two classes: a responsive class, containing images responsive to the user query, and a non-responsive class, which includes all images not classified by the classifier into the responsive class. The classifier 56 may assign a confidence level to the classification indicative of whether the classifier is more or less confident that the classification has been correct.

The selection component 22 or other component of the processor 12 may cause the GUI 24 to display a subset of images 38 responsive to the user query on the display 50. These displayed images may be all the images which have been classified by the classifier 56 into the responsive class (and optionally which are above a threshold confidence level). For example, full resolution images or reduced resolution images (thumbnails) of the images identified by the classifier 56 as being in the class(es) responsive to the user query may be displayed on the GUI 24. The GUI 24 may enable the user to select ones of the displayed images for printing, e.g., via the display 50, in the case of a touch screen, and/or via the keypad 52.

The classifier 56 may be trained on a set of training images. The training images used for training the classifier are generally selected to be representative of image content classes that the trained classifier is intended to recognize. In accordance with the method described in above-mentioned application Ser. No. 11/170,496, patches within the training images are clustered automatically to obtain a vocabulary of visual words. In some approaches, the visual words are obtained using K-means clustering. In other approaches, a probabilistic framework is employed and it is assumed that there exists an underlying generative model such as a Gaussian Mixture Model (GMM). In this case, the visual vocabulary is estimated using the Expectation-Maximization (EM) algorithm. In either case, each visual word corresponds to a grouping of low-level features. In one approach, an image can be characterized by the number of occurrences of each visual word. This high-level histogram representation is obtained by assigning each low-level feature vector to one visual word or to multiple visual words in a probabilistic manner. In other approaches, an image can be characterized by a gradient representation in accordance with the above-mentioned application Ser. No. 11/418,949.

Each training image of the set of training images is also suitably labeled, annotated, or otherwise associated with a manually assigned image class which describes the image more globally than the feature descriptors. The image classifier 66 may thus be trained to associate a set of feature descriptors with an image class (optionally with a confidence weighting). The image class may be identified by a verbal descriptor (“image containing person,” “landscape,” “beach scene,” “wedding,” “sporting event,” etc., or a unique code which represents the image class. The training image descriptors along with their high-level representations are used as input for training the image classifiers. In one approach, there is one such classifier per class. Typically, a decision boundary between the positive and negative samples (i.e. between the images that belong to the considered class and the others) is estimated. In one approach, this decision boundary may be a hyper-plane computed with the logistic regression algorithm.

As will be appreciated, the classifier 56 may incorrectly assign features or assign image classes in some instances, resulting, for example, in an image being assigned to a class which a user would not normally associate with the image. However, in some embodiments, the classifier 56 may incorporate feedback mechanisms and the like to provide modifications to the classification algorithms in response to user feedback, which enables progressive refinement of the classifier 56 over time.

Optionally, an image format converter 72 converts the image data into a suitable format for processing by the classifier 56. For example, the acquisition component 18 may accept images in a variety of different formats and the image format converter may convert all images to a common format. The image format converter may additionally undertake further processing of the image, for example, upsampling or downsampling, to provide the classifier with images all of the same resolution or of an appropriate resolution that is compatible with the processing capabilities of the classifier 56.

Optionally, an image quality evaluator 74 evaluates the image quality of input images. The image quality evaluator 74 may evaluate factors such as size of image file, resolution, blurring, contrast, and the like and assign an overall rating of image quality based on one or more of these factors. Thus, for example, if a user requests via the GUI, that the processor 12 identifies a maximum of ten images of cars, a measure of the image quality output by the evaluator 74 may be utilized in selecting ten images classed as cars from the subset of images classified by the classifier as cars if there are more than ten images in the subset.

Instructions to be executed by the various components of the selection component 22 may be stored in the main memory 16 or in a separate memory associated with the selection component. The components of the printer 10 may all be coupled by a system bus 76.

As will be appreciated, FIG. 1 is a high level functional block diagram of only a portion of the components which are incorporated into the printer 10. Since the configuration and operation of printers is well known, the other components will not be described in particular detail.

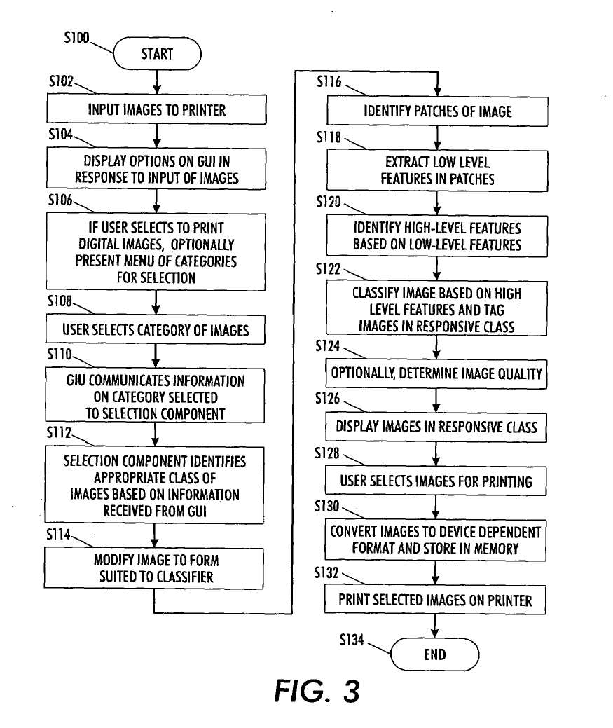

With reference now to FIG. 3, an exemplary method of processing images is shown which may be performed with the printer of FIGS. 1 and 2. As will be appreciated, the method may include fewer, more, or different steps from those illustrated and the steps need not be performed in the order shown. The method begins at step S100.

At step S102, a user inputs a set of digital images to the printer 10. For example, the user inserts the media card 32, or the acquisition component 18 otherwise registers that images have been acquired.

At step S104, the control system 12 may automatically cause the GUI 24 to display options for processing the images. One of the options may be for “media print photos” in which the user has the option of selecting some or all of the images for printing by the printer. Other options may include storing the images for later processing or the like.

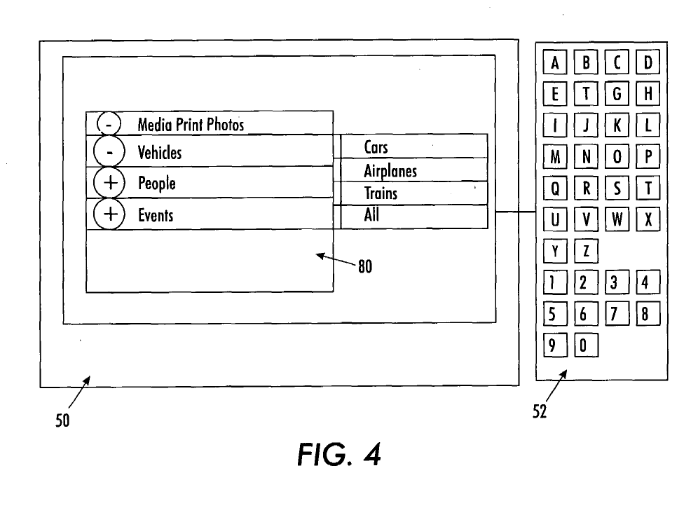

At step S106, the user may select the media print photos option. If the user selects the media print photos option, the control system 12 may automatically cause the GUI to display a list of categories for selection, e.g., in a drop down menu 80, as shown in FIG. 4. Exemplary categories displayed may include categories selected from landscapes, seascapes, vehicles, people, buildings, animals, events, and the like.

At step S108, a user may select one of the displayed categories or subcategories. For example, in FIG. 4, the user has touched the box labeled “vehicles” indicating that he wishes to be shown images containing vehicles, and is presented with a group of subcategories including automobiles, trains, airplanes, and the like. The user may opt to see all vehicles, by selecting the “All” option, or select a subcategory such as “cars,” indicating that he wishes to be shown images containing at least one car or an identifiable portion thereof. Alternatively, a user may input a category selection by entering a category on the keypad, for example, by typing the word “car” on the keypad. In some embodiments, the user may be able to select a combination of categories or sub categories, such as “people” and “cars,” indicating that the user wishes to be shown images which include at least one person and at least one car in the same image. The number of classes from which a user can select is thus virtually unlimited. Additionally, it is contemplated that there may be provision for updating the classes, by adding additional image classifiers directed to the new classes and by updating the control system to add the new classes to those categories which are displayed on the screen.

At step S110, the selection component 22 receives information from the GUI 24 identifying the categories or subcategories the user has selected. The selection component determines an appropriate class of images to be selected, based in whole or in part on the information received from the GUI 24 (step S112).

For each input image in turn, the method may then includes the following steps. At step S114, the image may be modified to place it in a form suitable for processing by the classifier. This may include modifying the resolution of the image, e.g., to render all images at the same resolution.

At step S116, the patch extractor may extract one or more patches (subsamples) of the input image (optionally as modified at step S114) for analysis, each patch comprising an area of interest. In one embodiment a Harris affine detector technique is used for identification of patches (as described by Mikolajczyk and Schmid, “An Affine Invariant Interest Point Detector ECCV, 2002, and “A Performance Evaluation Of Local Descriptors,” in IEEE Conference on Computer vision and Pattern Recognition (June 2003). Alternatively, features can be extracted on a regular grid, or at random points within the image, or so forth, avoiding the need for patch identification.

In the following steps, the classifier applies selection rules for identifying images in the selected class. For example, at step S118, any distinguishable features in the patch are extracted, e.g., by comparing the patch information with stored feature information using the methods as described, for example, in application Ser. Nos. 11/418,949 and 11/170,496, discussed above. For example, the low level feature extractor 62 generates a features vector or other features-based representation of each patch in the image. Image features are typically quantitative values that summarize or characterize, for the patch region, aspects of the image data within the region, such as spatial frequency content, an average intensity, color characteristics, and/or other characteristic values. In some embodiments, about fifty features are extracted from each patch. However, the number of features that can be extracted is not limited to any particular number or type of features. In some embodiments, Scale Invariant Feature Transform (SIFT) descriptors (as described by Lowe, “Object Recognition from Local Scale-Invariant Features,” ICCV (International Conference on ComputerVision), 1999) are computed on each patch region. SIFT descriptors are multi-image representations of an image neighborhood, such as Gaussian derivatives computed at, for example, eight orientation planes over a four-by-four grid of spatial locations, giving a 128-dimensional vector (that is, 128 features per features vector in these embodiments). Other feature extraction algorithms may be employed to extract features from the patches. Examples of some other suitable descriptors are set forth by K. Mikolajczyk and C. Schmid, in “A Performance Evaluation of Local Descriptors,” Proceedings of the Conference on Computer Vision and Pattern Recognition (CVPR), Madison, Wis., USA, June 2003.

Once the low-level feature vectors or other representations have been derived, they are used to form a high-level representation (S120).

At step S122, the image is classified based on the high-level features identified at step S120. If the image classifier 64 includes a plurality of image classifiers, one for each of the designated classes, then step S122 may include using the appropriate image classifier to classify the image. The appropriate image classifier 66 then classifies the image, based on the identified high-level features. The image classifier may tag the image as being in the designated class or otherwise identify the image as being in the responsive class. Otherwise, the image may be left untagged or otherwise identified as not being within the designated class. In one embodiment, a score is obtained whose value depends on which side of the decision boundary the high-level representation falls and on the distance to the decision boundary. If the score exceeds a threshold value, a match is assumed and the image is assigned to that image class. Alternatively, the image class which generates the highest computed score is selected. In another embodiment, an image classifier 66 is trained to assign an image to one of a plurality of classes.

The classes for which the classifier 56 is trained to identify images may correspond directly to the categories presented to the user. In another embodiment, the classifier 56 may be trained to identify a larger number of classes than the categories displayed on the GUI 24. In this way, the printer can be tailored by a user to display particular categories of interest. For example, the printer may be customized by the user only to display vehicle categories. In one embodiment, a category may correspond to a combination of classes, in which case, the classifier outputs images which have been classed in all of the corresponding classes.

In another embodiment, the classifier 56 may automatically assign all of the input images to one or more of the designated classes. In this embodiment, the classification steps S116, S118, S120, and S122 may be completed prior to or during user selection of a category (step S108). Once the category is input, the classifier outputs the images in the responsive class.

At step S124, the image quality of the identified images may be determined. Once all the images in the input set have been classified and optionally their image quality evaluated, the method proceeds to step S126, where the GUI 24, under the control of processor 12, displays a subset of the input images. The subset of images may be those images which have been identified by the classifier as being in the designated class responsive to the user query. In particular, the control system 12 may cause the responsive images, or a representation thereof, such as a thumbnail, to be displayed on the screen 50.

For example, if the user has selected the category cars, the GUI 24 displays the subset of images which are identified by the classifier as comprising a car or a recognizable part thereof. Or, if the user has elected to display a limited number of images, the GUI 24 displays a subset comprising the limited number. The subset may then contain images identified on the basis of the assigned class and the image quality of those images.

At step S128, the user may select one or more of the displayed images in the subset for printing. For example, the user may touch the screen on or adjacent an image to select the image for printing or enter its identifier (a unique alphanumeric string, or the like) via the keypad. Or, the GUI may present an option such as “select all” which allows the user to select all the images in the subset for printing. Or the user may opt to begin a new search by inputting a new or modified query.

At step S130, images selected for printing may be processed by the image processing component 20, if this step has not been previously performed prior to image selection. The processed images, in device dependent format, are then stored in memory 16, from which they are retrieved by the marking engine 14 for printing on print media at step S132. The method ends at step S134.

The computer implemented steps of the method illustrated in FIG. 3 may be implemented in a computer program product that may be executed on a computer. The computer program product may be a tangible computer-readable recording medium on which a control program is recorded, or may be a transmittable carrier wave in which the control program is embodied as a data signal. The computer readable medium can comprise an optical or magnetic disk, magnetic cassette, flash memory card, digital video disk, random access memory (RAM), read-only memory (ROM), combination thereof, or the like for storing the program code.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A printer comprising:
an acquisition component which acquires image data comprising a set of digital images generated by a digital image generation device;
memory which stores the acquired set of images;
a user input device through which a user selects an image category from a plurality of image categories;
a processor in communication with the input device and memory which identifies a, subset of the digital images based on the image category selected by the user, the processor including a classifier trained to classify images according to image content;
a display in communication with the processor for displaying images in the subset; and
a marking engine in communication with the processor for printing images from the subset selected by the user.

2. The printer of claim 1, further comprising a device interface, in communication with the acquisition component, which receives a memory card of the digital image generation device.

3. The printer of claim 1, wherein the classifier is trained to classify an image based on features identified in at least one patch of the image.

4. The printer of claim 3, wherein the classifier comprises a low level feature extractor which generates a features-based representation of each patch in the image comprising a set of local low-level features.

5. The printer of claim 4, wherein the classifier further comprises a high-level features extractor which transforms the set of local low-level features into a high level representation comprising at least one global high-level feature which characterizes the content of the image as a whole.

6. The printer of claim 1, wherein the classifier stores a vocabulary of visual words and wherein the classifier classifies an image based on a subset of the visual words identified in the image.

7. The printer of claim 1, wherein the classifier is trained to assign images to a plurality of classes, each of the classes corresponding to one of the plurality of image categories.

8. The printer of claim 1, wherein the user input device comprises a graphical user interface which includes the display.

9. The printer of claim 8, wherein the graphical user interface is configured for displaying a menu of image categories.

10. The printer of claim 1 wherein the marking engine comprises at least one of a xerographic marking device and an ink jet marking device.

11. The printer of claim 1, further comprising a housing which supports the user input device, processor, display, and marking engine.

12. The printer of claim 1, wherein the categories include a plurality of categories selected from the group consisting of vehicles, people, animals, events, landscapes, buildings, and sub-categories thereof.

13. In a printer comprising an acquisition component, a user input device, an automated classifier which is trained to classify images based on image content, and a marking engine, a method for processing images comprising:
acquiring image data with the acquisition component, the image data comprising a set of digital images;
identifying a class of images of interest based on information received from the user input device;
classifying the input images with the automated classifier to identify a subset of the set of digital images in the identified class; and
displaying images in the subset of digital images, whereby a user is able to select images from the subset for printing by the marking engine.

14. The method of claim 13, further comprising, after displaying the images, printing a user-selected group of the images in the subset.

15. The method of claim 13, wherein the acquiring includes acquiring the digital data from a memory card of a digital image generation device inserted in a receiving slot of the printer.

16. The method of claim 15, wherein the digital image generation device comprises a camera.

17. The method of claim 13, wherein the classifying comprises, for each image in the set, identifying low level features of at least one patch of the image and assigning the image to a class selected from a plurality of classes based on the identified low-level features.

18. The method of claim 17, wherein the classifying further comprises, identifying at least one global feature of the image as a whole based on the low level features.

19. The method of claim 13, wherein the classifying includes comparing features of the patches to a vocabulary of visual words.

20. The method of claim 13, wherein the images in the set of images are photographs.

21. A tangible computer readable medium comprising instructions, which when executed by a processor causes the processor to implement the method of claim 13.

22. A method comprising:
transferring digital image data comprising a set of photographs from a digital camera to a printer;
storing the set of images in memory of the printer;
receiving a user input query from a graphical user interface;
identifying a subset of the images responsive to the query based on image content;
displaying the subset of images on the graphical user interface; and
printing images from the subset selected by the user.
